(19) United States
(12) Patent Application Publication
(10) Pub. No.: US 2025/0052295 A1
(43) Pub. Date: Feb. 13, 2025

(54) DAMPING VALVE AND SHOCK ABSORBER

(71) Applicant: KYB Corporation, Tokyo (JP)

(72) Inventor: Takeshi YASUI, Tokyo (JP)

(73) Assignee: KYB Corporation, Tokyo (JP)

(21) Appl. No.: 18/718,634

(22) PCT Filed: Jan. 13, 2023
(86) PCT No.: PCT/JP2023/000739

§ 371 Date: Jun. 11, 2024

(30) Foreign Application Priority Data
Mar. 16, 2022 (JP) 2022-040865

(51) Int. Cl. F16F 9/348

(52) U.S. Cl. CPC F16F 9/3481; F16F 2222/12

(57) ABSTRACT

A damping valve of the present invention includes: a partition wall body that is annular, and is inserted into a cylindrical body, is radially positioned only by the cylindrical body, and has an annular outer circumferential valve seat protruding axially from an axial one end and a port provided on an inner circumferential side of the outer circumferential valve seat; a valve stopper having an annular inner circumferential valve seat facing the one end of the partition wall body and having an outer diameter smaller than that of the outer circumferential valve seat; and an annular leaf valve that is interposed between the outer circumferential valve seat and the inner circumferential valve seat and is set to be open to both the inside and the outside to open and close the port, wherein the partition wall body includes an aligning portion that aligns the leaf valve with respect to the outer circumferential valve seat.

### TECHNICAL FIELD

The present invention relates to a damping valve and a shock absorber.

### BACKGROUND ART

The shock absorber includes, for example, a cylinder, a piston movably inserted into the cylinder, and a piston rod movably inserted into the cylinder and connected to the piston, and is interposed between a vehicle body and a wheel of a vehicle and exerts a damping force to suppress the vibration of the vehicle body and the wheel. The damping force exerted by the shock absorber is exerted by the damping valve and affects ride comfort in the vehicle. In recent years, there is a demand for the exertion of a sufficient damping force to suppress the vibration in the shock absorber used for a suspension of the vehicle even when extending or contracting at an extremely low speed in order to improve the ride comfort.

In order to meet such a demand, for example, as disclosed in WO 2021/084956, the damping valve may include: a valve disc that is annular and loosely fitted to an outer circumference of the piston rod, is movably mounted in the axial direction, and has a port and an outer circumferential valve seat surrounding the outer circumference of the port; a valve stopper that is fixed to the piston rod, faces the valve disc axially, and has an inner circumferential valve seat that is annular and has an outer diameter smaller than an inner diameter of the outer circumferential valve seat; and a leaf valve that is interposed between the outer circumferential valve seat and the inner circumferential valve seat and is set to be open to both the inside and the outside. The damping valve exerts a damping force when the leaf valve gives resistance to the flow of the hydraulic oil passing through the port while the shock absorber extends and contracts at an extremely low speed.

### CITATION LIST

### Patent Literature

Patent Literature 1: WO 2021/084956

### SUMMARY OF INVENTION

### Technical Problem

In the damping valve configured as described above, since the valve disc is loosely fitted to the piston rod and is slidably in contact with the inner circumference of the cylinder, the valve disc may be offset radially with respect to the piston rod. On the other hand, since the leaf valve is aligned with respect to the piston rod, when the valve disc is axially offset with respect to the piston rod, the leaf valve is eccentrically seated on the outer circumferential valve seat provided on the valve disc.

When the leaf valve is eccentrically seated with respect to the outer circumferential valve seat of the valve disc, the deflection of the leaf valve is not circumferentially uniform, and a gap may be formed between the leaf valve and the outer circumferential valve seat although the leaf valve is seated on the outer circumferential valve seat.

In such a situation, when the shock absorber extends and contracts at an extremely low speed, the hydraulic oil passes through the gap formed between the leaf valve and the outer circumferential valve seat, and the damping force is reduced, and thus it is difficult to exert a damping force of a desired magnitude, and it is impossible to obtain damping force characteristics (characteristics of the damping force generated by the shock absorber with respect to the extension and contraction speed of the shock absorber) that are good for suppressing the vibration when the shock absorber extends and contracts at an extremely low speed.

Therefore, an object of the present invention is to provide a damping valve and a shock absorber capable of exerting a sufficient damping force even when the shock absorber extends and contracts at an extremely low speed and obtaining good damping force characteristics for suppressing such extension and contraction.

### Solution to Problem

In order to solve the above problem, a damping valve of the present invention includes: a partition wall body that is annular, is inserted into a cylindrical body, is radially positioned only by the cylindrical body, and has an annular outer circumferential valve seat protruding axially from axial one end and a port provided on an inner circumferential side of the outer circumferential valve seat; a valve stopper that has an annular inner circumferential valve seat facing the one end of the partition wall body and having an outer diameter smaller than that of the outer circumferential valve seat; and an annular leaf valve that is interposed between the outer circumferential valve seat and the inner circumferential valve seat and is set to be open to both the inside and the outside to open and close the port, wherein the partition wall body includes an aligning portion that aligns the leaf valve with respect to the outer circumferential valve seat.

In the damping valve configured as described above, since the leaf valve is aligned with respect to the outer circumferential valve seat by the aligning portion provided in the partition wall body radially positioned only by the cylindrical body, in a state where the leaf valve is seated on the outer circumferential valve seat and the inner circumferential valve seat, a gap is not formed between an outer circumference of the leaf valve and the outer circumferential valve seat, and a gap that affects the damping force is also not formed between an inner circumference of the leaf valve and the inner circumferential valve seat. Therefore, according to the damping valve, it is possible to prevent leakage of liquid from the gap, and generate a sufficient damping force in the shock absorber even when the flow rate of the liquid passing through the port is small.

### BRIEF DESCRIPTION OF DRAWINGS

FIG. 1 is a longitudinal sectional view of a shock absorber including a damping valve in one embodiment.

FIG. 2 is an enlarged sectional view of a piston portion of the shock absorber including the damping valve in the one embodiment.

FIG. 3 is a graph showing a damping force characteristics of the shock absorber including the damping valve in the one embodiment.

FIG. 4 is an enlarged sectional view of the piston portion of the shock absorber including the damping valve in one modification of the one embodiment.

### DESCRIPTION OF EMBODIMENTS

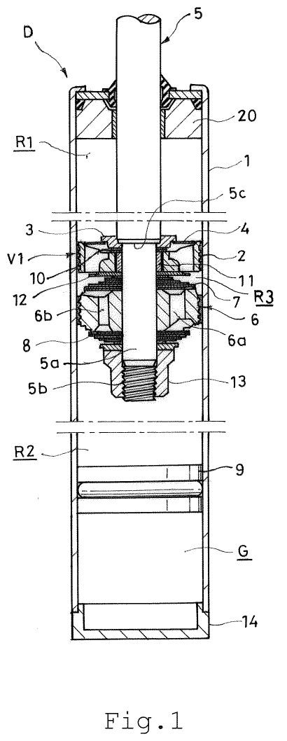

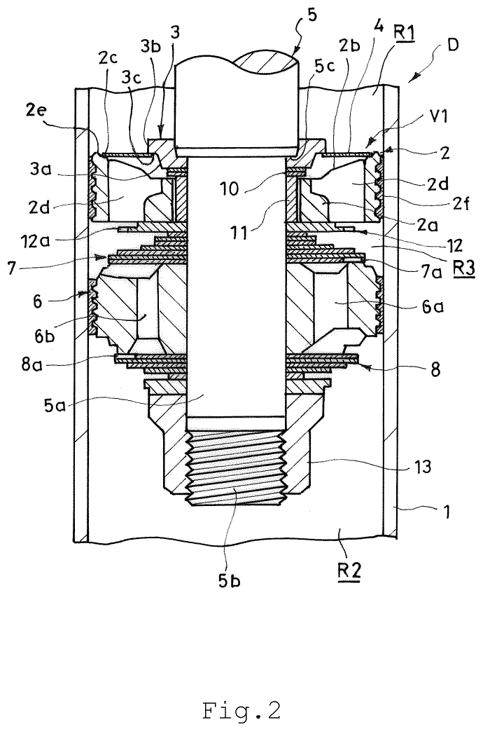

Hereinafter, the present invention will be described based on the embodiments illustrated in the drawings. As illustrated in FIGS. 1 and 2, a damping valve V1 in one embodiment includes: a sub-piston 2 as a partition wall body that is annular and is inserted into a cylinder 1 as a cylindrical body, is radially positioned only by the cylinder 1, and has an annular outer circumferential valve seat 2c and a port 2d; a valve stopper 3 having an annular inner circumferential valve seat 3c facing one end 2b of the sub-piston 2; and an annular leaf valve 4 that is interposed between the outer circumferential valve seat 2c and the inner circumferential valve seat 3c and is set to be open to both the inside and the outside to open and close the port 2d, wherein the damping valve V1 is applied to a shock absorber D.

On the other hand, the shock absorber D to which the damping valve V1 is applied includes a cylinder 1, a piston rod 5 that is inserted into the cylinder 1 so as to be axially movable, a piston 6 as a main partition wall body that is attached to the piston rod 5 and is inserted into the cylinder 1 so as to be axially movable, main valves 7 and 8 that open and close main ports 6a and 6b provided in the piston 6, and the damping valve V1. Further, in the case of the shock absorber D, for example, it is used by being interposed between a vehicle body and an axle of a vehicle, which is not illustrated, to suppress vibrations of the vehicle body and the wheels.

Hereinafter, some components in the damping valve V1 and the shock absorber D will be described in detail. As illustrated in FIG. 1, an annular rod guide 20 is mounted on the upper end of the cylinder 1, and the lower end of the cylinder 1 is closed by a cap 14. Then, in the cylinder 1, the piston rod 5 having a distal end to which the piston 6 and the sub-piston 2 are mounted is movably inserted.

The piston rod 5 is slidably inserted into the rod guide 20 and inserted into the cylinder 1 so as to axially movable, and axial movement is guided by the rod guide 20. In addition, the inside of the cylinder 1 is partitioned by the piston 6 and the sub-piston 2 into an extension side chamber R1 and a compression side chamber R2 that are filled with liquid. Note that, although the liquid is the hydraulic oil in the embodiment of the present embodiment, it is also possible to use liquid such as water and an aqueous solution in addition to the hydraulic oil, for example.

Note that a gas chamber G is defined inside the cylinder 1 below the compression side chamber R2 by a free piston 9 slidably inserted into the cylinder 1. Further, when the piston rod 5 is displaced axially with respect to the cylinder 1, the free piston 9 is displaced axially with respect to the cylinder 1 to be extended or contracted in the gas chamber G in response to a change of the volume of the piston rod 5 inside the cylinder 1, and the volume of the piston rod 5 moving in and out of the cylinder 1 is compensated by a change of the volume of the gas chamber G. In this manner, the shock absorber D is a so-called monotube shock absorber, but may be configured as a double cylinder type shock absorber including a reservoir outside the cylinder 1.

Returning to the above, the piston rod 5 includes a small-diameter portion 5a provided at the distal end which is the lower end in FIG. 1, a screw portion 5b provided on an outer circumference of a distal end of the small-diameter portion 5a, and a stepped portion 5c formed by providing the small-diameter portion 5a, and the annular piston 6 and the sub-piston 2 are mounted on the outer circumference of the small-diameter portion 5a.

The piston 6 is annular, is fixed to the outer circumference of the small-diameter portion 5a, and has an outer circumference slidably in contact with an inner circumference of the cylinder 1. In addition, the piston 6 includes a compression side main port 6a and an extension side main port 6b as main ports. The sub-piston 2 has an outer circumference slidably in contact with the inner circumference of the cylinder 1, and includes the port 2d. The piston 6 and the sub-piston 2 face each other while being separated axially from each other, and cooperatively partition the inside of the cylinder 1 into the extension side chamber R1 and the compression side chamber R2, and an intermediate chamber R3 is formed between the piston 6 and the sub-piston 2. The intermediate chamber R3 communicates with the compression side chamber R2 through the compression side main port 6a and the extension side main port 6b provided in the piston 6, and communicates with the extension side chamber R1 through the port 2d provided in the sub-piston 2. Thus, the compression side main port 6a, the extension side main port 6b, the intermediate chamber R3, and the port 2d form a passage that causes the extension side chamber R1 and the compression side chamber R2 to communicate with each other.

Further, the valve stopper 3, the leaf valve 4, a spacer 10, a tubular collar 11, the sub-piston 2, a main valve stopper 12, a compression side main leaf valve 7 as a main leaf valve, the piston 6, and an extension side main leaf valve 8 as the main leaf valve are mounted to the outer circumference of the small-diameter portion 5a of the piston rod 5 as illustrated in FIGS. 1 and 2. Further, the valve stopper 3, the spacer 10, the collar 11, the main valve stopper 12, the compression side main leaf valve 7, the piston 6, and the extension side main leaf valve 8 are sandwiched and fixed by the stepped portion 5c of the piston rod 5 and a piston nut 13 screwed to the screw portion 5b.

As illustrated in FIG. 2, the valve stopper 3 includes a fitting portion 3a that is annular and has a reduced inner diameter on the lower end side in FIG. 2, a flange portion 3b protruding from an outer circumference of the upper end in FIG. 2 of the fitting portion 3a toward an outer circumferential side, and an annular inner circumferential valve seat 3c formed on an outer circumference of the lower end in FIG. 2 of the flange portion 3b facing the sub-piston 2. The inner diameter of the fitting portion 3a on the lower end side in FIG. 2 is set to be fitted to the outer circumference of the small-diameter portion 5a of the piston rod 5, and the inner diameter of the fitting portion 3a on the upper end side in FIG. 2 is larger than an outer diameter of the piston rod 5 on the upper side in FIG. 2 of the small-diameter portion 5a. Thus, when the valve stopper 3 is fitted to the small-diameter portion 5a of the piston rod 5, an inner circumference of the fitting portion 3a on the lower end side is fitted to the small-diameter portion 5a of the piston rod 5, and thus the valve stopper 3 is radially positioned with respect to the piston rod 5, while a stepped portion at a boundary between the lower end and the upper end of the fitting portion 3a abuts on the stepped portion 5c of the piston rod 5, and thus the valve stopper 3 is axially positioned with respect to the piston rod 5.

In the present embodiment, the spacer 10 is formed of a plurality of annular plates whose outer diameter is set to be larger than an outer diameter of the collar 11 and whose inner diameter is set to a diameter that can be fitted to the small-diameter portion 5a of the piston rod 5, and is fitted to the outer circumference of the small-diameter portion 5a of the piston rod 5. An axial position of the collar 11 with respect to the piston rod 5 and the position of the movement limit of the sub-piston 2 to the upper side in FIG. 2 can be adjusted by adjusting the number of stacked annular plates constituting the spacer 10. Therefore, if the adjustment of the position of the collar 11 is not required and the movement limit of the sub-piston 2 is restricted by the fitting portion 3a of the valve stopper 3, the spacer 10 can be omitted, and the collar 11 may be formed of a single annular plate depending on the position of the collar.

The collar 11 is a cylindrical component whose outer diameter is set to be smaller than outer diameters of the spacer 10 and the fitting portion 3a of the valve stopper 3 and whose inner diameter is set to a diameter that can be fitted to the small-diameter portion 5a of the piston rod 5, and is fitted to the outer circumference of the small-diameter portion 5a of the piston rod 5.

The sub-piston 2 is annular, has an outer diameter set to a diameter slidably in contact with the inner circumference of the cylinder 1, has an inner diameter set to a diameter larger than the outer diameter of the collar 11, and is loosely fitted to the outer circumference of the collar 11.

Specifically, the sub-piston 2 includes an annular main body 2a, an annular outer circumferential valve seat 2c protruding axially from the one end 2b that is an axial upper end in FIG. 2 of the main body 2a, a plurality of ports 2d provided side by side on the same circumference on the inner circumferential side of the outer circumferential valve seat 2c in the main body 2a, an annular protrusion 2e protruding axially from an outer circumferential side of the one end 2b of the main body 2a with respect to the outer circumferential valve seat 2c, and a piston ring 2f mounted on an outer circumference of the main body 2a and slidably in contact with the inner circumference of the cylinder 1.

An axial height of the one end 2b of the main body 2a increases from the inner circumference toward the outer circumference, and an axial length of the main body 2a on the inner circumferential side is slightly shorter than an axial length of the collar 11.

As described above, the ports 2d are arranged at equal intervals on the same circumference concentric with respect to the main body 2a, and cause the intermediate chamber R3 between the sub-piston 2 and the piston 6 to communicate with the extension side chamber R1 through the main body 2a.

The outer circumferential valve seat 2c protrudes axially from the main body 2a toward the upper side in FIG. 2 so as to surround an outer circumference of the port 2d, and is arranged on the upper side in FIG. 2 with respect to the inner circumferential valve seat 3c provided in the flange portion 3b of the valve stopper 3. In addition, an inner diameter of the outer circumferential valve seat 2c is larger than an outer diameter of the inner circumferential valve seat 3c of the valve stopper 3.

The protrusion 2e is annular and protrudes axially toward the upper side in FIG. 2 from an outer circumference of the outer circumferential valve seat 2c, and surrounds the outer circumferential valve seat 2c. Note that the protrusion 2e may not be annular, and may be installed in a plural number on the same circumference surrounding the outer circumferential valve seat 2c.

When the sub-piston 2 is loosely fitted to the collar 11, a gap is formed between the inner circumference of the sub-piston 2 and the collar 11, and thus the sub-piston 2 is radially movable with respect to the collar 11. In addition, since the axial length of the inner circumference of the sub-piston 2 is shorter than the axial length of the collar 11, the sub-piston 2 can be slightly displaced in the vertical direction in FIG. 2, which is the axial direction, between the spacer 10 and the main valve stopper 12. Furthermore, when the sub-piston 2 is inserted into the cylinder 1, an outer circumference of the piston ring 2f is slidably in contact with the inner circumference of the cylinder 1, and the sub-piston 2 is loosely fitted to the collar 11, and thus the sub-piston 2 is radially positioned only by the cylinder 1. When the sub-piston 2 is loosely fitted to the outer circumference of the collar 11, the inner circumferential valve seat 3c of the valve stopper 3 faces the inner circumferential side of the main body 2a of the sub-piston 2.

The leaf valve 4 is annular, has an inner diameter smaller than the outer diameter of the inner circumferential valve seat 3c and larger than the outer diameter of the fitting portion 3a of the valve stopper 3, and has an outer diameter set such that the outer circumference of the leaf valve 4 abuts on the protrusion 2e arranged on the outer circumferential side of the outer circumferential valve seat 2c. Since the outer circumference of the leaf valve 4 abuts on the annular protrusion 2e of the sub-piston 2, the leaf valve 4 is aligned with respect to the outer circumferential valve seat 2c of the sub-piston 2 by the protrusion 2e and is radially positioned so as to be concentric with the outer circumferential valve seat 2c. In this manner, the protrusion 2e functions as an aligning portion that aligns the leaf valve 4 with respect to the outer circumferential valve seat 2c. In addition, the inner diameter of the leaf valve 4 is larger than the outer diameter of the fitting portion 3a to such an extent that the inner circumferential surface of the leaf valve 4 does not come into contact with the fitting portion 3a of the facing valve stopper 3 even when being aligned by the protrusion 2e. Therefore, consideration is taken so that the alignment of the leaf valve 4 by the protrusion 2e is not disturbed by the valve stopper 3.

Note that, as described above, the protrusion 2e may not be annular as long as the leaf valve 4 can be aligned so as to be concentric with the outer circumferential valve seat 2c, and thus a plurality of protrusions 2e may be provided at intervals on the same circumference surrounding the outer circumferential valve seat 2c. In addition, the shape of the protrusion 2e can also be modified in any manner as long as the leaf valve 4 can be aligned so as to be concentric with the outer circumferential valve seat 2c.

The leaf valve 4 is interposed between the inner circumferential valve seat 3c and the outer circumferential valve seat 2c in a state where the upper end in FIG. 2 of the inner circumference is seated on the inner circumferential valve seat 3c and the lower end in FIG. 2 of the outer circumference is seated on the outer circumferential valve seat 2c. The leaf valve 4 receives pressure from the extension side chamber R1 side, and its inner circumferential side is deflected to the lower side in FIG. 2 with its outer circumference supported by the outer circumferential valve seat 2c as a fulcrum, and is separated from the inner circumferential valve seat 3c of the valve stopper 3 to cause the port 2d to communicate with the compression side chamber R2. On the other hand, the leaf valve 4 receives pressure from the intermediate chamber R3 side, and its outer circumferential side is deflected to the upper side in FIG. 2 with its inner circumference supported by the inner circumferential valve seat 3c as a fulcrum, and is separated from the outer circumferential valve seat 2c of the sub-piston 2 to cause the port 2d to communicate with the extension side chamber R1.

As described above, the leaf valve 4 functions as a de Carbon valve that is open to both the inside and the outside in which the valve opens by separating from the inner circumferential valve seat 3c when the pressure of the extension side chamber R1 becomes higher than the pressure of the intermediate chamber R3 and the differential pressure between the two chambers reaches a valve opening pressure, and the valve opens by separating from the outer circumferential valve seat 2c when the pressure of the intermediate chamber R3 becomes higher than the pressure of the extension side chamber R1 and the differential pressure between the two chambers reaches the valve opening pressure. Since the axial height of the main body 2a in the sub-piston 2 decreases as it goes toward the inner circumference, a sufficient space such that the inner circumference of the leaf valve 4 can be deflected to the lower side in FIG. 2 is secured between the inner circumferential valve seat 3c and the main body 2a of the sub-piston 2.

In addition, since the outer circumferential valve seat 2c of the sub-piston 2 is arranged at a higher position in FIG. 2 than the inner circumferential valve seat 3c of the valve stopper 3, the leaf valve 4 is given an initial deflection when interposed between the inner circumferential valve seat 3c and the outer circumferential valve seat 2c, and presses the inner circumferential valve seat 3c and the outer circumferential valve seat 2c with a resilient force generated by the leaf valve 4 itself. Since the leaf valve 4 is given the initial deflection in this manner, a valve opening pressure at which the leaf valve 4 is separated from the inner circumferential valve seat 3c and the outer circumferential valve seat 2c is set, and thus the valve opening pressure can be adjusted by adjusting the initial deflection amount. Note that, since the initial deflection amount given to the leaf valve 4 can be adjusted by the difference in the axial distance between the inner circumferential valve seat 3c and the outer circumferential valve seat 2c, the valve opening pressure can be adjusted by adjusting the thickness of the annular plate of the spacer 10 and the number of stacked plates.

The main valve stopper 12 has a circular annular shape, has an inner diameter set to a diameter that can be fitted to the small-diameter portion 5a of the piston rod 5, and is fitted to the small-diameter portion 5a of the piston rod 5. The main valve stopper 12 includes a relief portion 12a formed of an annular recess on an outer circumference of an end facing the sub-piston 2, and the installation of the relief portion 12a causes the main valve stopper 12 not to close the port 2d even when it faces the port 2d of the sub-piston 2.

Subsequently, the compression side main leaf valve 7 is a stacked leaf valve formed by stacking a plurality of annular plates having an inner diameter set to a diameter that can be fitted to the small-diameter portion 5a of the piston rod 5, and placed on the upper end in FIG. 2 of the piston 6 to open and close an outlet end of the compression side main port 6a. An orifice 7a formed by a notch is provided on an outer circumference of the annular plate of the compression side main leaf valve 7 facing the piston 6. In the compression side main leaf valve 7, the inner circumferential side is sandwiched between the piston nut 13 and the stepped portion 5c, and only deflection on the outer circumferential side is permitted.

Further, the compression side main leaf valve 7 causes the compression side chamber R2 and the intermediate chamber R3 to communicate with each other only through the orifice 7a in a state of being entirely in contact with the piston 6, and is deflected to open the compression side main port 6a when the pressure of the compression side chamber R2 received through the compression side main port 6a becomes higher than the pressure of the intermediate chamber R3 and a differential pressure therebetween reaches a valve opening pressure. The valve opening pressure of the compression side main leaf valve 7 is set higher than the valve opening pressure of the leaf valve 4. Note that an outer diameter of the annular plate forming the compression side main leaf valve 7 can be modified in any manner according to the setting of resistance given to the flow of hydraulic oil passing through the compression side main port 6a by the compression side main leaf valve 7.

The extension side main leaf valve 8 is a stacked leaf valve formed by stacking a plurality of annular plates having an inner diameter set to a diameter that can be fitted to the small-diameter portion 5a of the piston rod 5, and placed on the lower end in FIG. 2 of the piston 6 to open and close an outlet end of the extension side main port 6b. An orifice 8a formed by a notch is provided on an outer circumference of the annular plate of the extension side main leaf valve 8 facing the piston 6. In the extension side main leaf valve 8, the inner circumferential side is sandwiched between the piston nut 13 and the stepped portion 5c, and only deflection on the outer circumferential side is permitted.

Further, the extension side main leaf valve 8 causes the intermediate chamber R3 and the compression side chamber R2 to communicate with each other only through the orifice 8a in a state of being entirely in contact with the piston 6, and is deflected to open the extension side main port 6b when the pressure of the intermediate chamber R3 becomes higher than the pressure of the compression side chamber R2 received through the extension side main port 6b and the differential pressure therebetween reaches the valve opening pressure. The valve opening pressure of the extension side main leaf valve 8 is set higher than the valve opening pressure of the leaf valve 4. Note that an outer diameter of the annular plate forming the extension side main leaf valve 8 can be modified in any manner according to the setting of resistance given to the flow of hydraulic oil passing through the extension side main port 6b by the extension side main leaf valve 8.

As described above, the damping valve V1 includes: the sub-piston 2 as a partition wall body that is annular, and is inserted into the cylinder 1 as a cylindrical body, is radially positioned only by the cylinder 1, and has the annular outer circumferential valve seat 2c protruding axially from the axial one end 2b and the port 2d provided on the inner circumferential side of the outer circumferential valve seat 2c; the valve stopper 3 having the annular inner circumferential valve seat 3c facing the one end 2b of the sub-piston 2 and having an outer diameter smaller than that of the outer circumferential valve seat 2c; and the annular leaf valve 4 that is interposed between the outer circumferential valve seat 2c and the inner circumferential valve seat 3c and is set to be open to both the inside and the outside to open and close the port 2d. In addition, the sub-piston 2 of the damping valve V1 includes the protrusion 2e as an aligning portion that aligns the leaf valve 4 with respect to the outer circumferential valve seat 2c.

Hereinafter, an operation of the damping valve V1 and the shock absorber D will be described. First, an operation when the piston rod 5 moves to the upper side in FIG. 1 with respect to the cylinder 1 and the shock absorber D performs an extension operation will be described. When the shock absorber D performs the extension operation, the piston 6 and the sub-piston 2 move to the upper side in FIG. 1 with respect to the cylinder 1, and thus, the extension side chamber R1 is compressed and the compression side chamber R2 is enlarged.

Then, when the pressure in the extension side chamber R1 increases and the difference between the pressure in the extension side chamber R1 and the pressure in the intermediate chamber R3 reaches the valve opening pressure of the leaf valve 4, the leaf valve 4 deflects its inner circumferential side to the lower side in FIG. 2, separates from the inner circumferential valve seat 3c, and opens the port 2d of the sub-piston 2.

In a state where the extension speed of the shock absorber D is an extremely low speed and the extension side main leaf valve 8 is not opened, the hydraulic oil in the extension side chamber R1 deflects the inner circumference of the leaf valve 4, passes through the port 2d, passes through the intermediate chamber R3, passes through the main ports 6a and 6b on the compression side and the extension side and the orifices 7a and 8a, and moves to the compression side chamber R2.

In this manner, when the extension speed of the shock absorber D is within an extremely low speed range during the extension operation, a flow rate of the hydraulic oil passing through the orifices 7a and 8a is very small, and thus, a pressure loss generated when the hydraulic oil passes through the leaf valve 4 is larger than a pressure loss generated when the hydraulic oil passes through the orifices 7a and 8a. Thus, the damping force is exerted mainly by the leaf valve 4 when the shock absorber D extends in the extremely low speed range.

In addition, when the extension speed of the shock absorber D is within a low speed range, the extension side main leaf valve 8 is not opened, but the pressure loss in the orifices 7a and 8a increases, and thus, the shock absorber D exerts the damping force with the leaf valve 4 and the orifices 7a and 8a.

Furthermore, when the extension speed of the shock absorber D becomes high during the extension operation, the extension side main leaf valve 8 is deflected and opened to largely open the extension side main port 6b, and the shock absorber D exerts the damping force mainly with the leaf valve 4 and the extension side main leaf valve 8.

Next, an operation when the piston rod 5 moves to the lower side in FIG. 1 with respect to the cylinder 1 and the shock absorber D performs a contraction operation will be described. When the shock absorber D performs the contraction operation, the piston 6 and the sub-piston 2 move to the lower side in FIG. 1 with respect to the cylinder 1, and thus, the compression side chamber R2 is compressed, and the extension side chamber R1 is enlarged.

Then, the pressure in the compression side chamber R2 increases, and the hydraulic oil in the compression side chamber R2 moves to the intermediate chamber R3 via the compression side and extension side main ports 6a and 6b and the orifices 7a and 8a when the compression side main leaf valve 7 is closed, and mainly via the compression side main port 6a when the compression side main leaf valve 7 is open. When the difference between the pressure in the intermediate chamber R3 and the pressure in the extension side chamber R1 reaches the valve opening pressure of the leaf valve 4, the leaf valve 4 deflects its outer circumferential side to the upper side in FIG. 2, separates from the outer circumferential valve seat 2c, and opens the port 2d of the sub-piston 2.

In a state where the extension speed of the shock absorber D is an extremely low speed and the compression side main leaf valve 7 is not opened, the hydraulic oil in the compression side chamber R2 passes through the main ports 6a and 6b on the compression side and the extension side and the orifices 7a and 8a, passes through the intermediate chamber R3, deflects the outer circumference of the leaf valve 4 and passes through the port 2d, and moves to the extension side chamber R1.

In this manner, when the contraction speed of the shock absorber D is within an extremely low speed range during the contraction operation, a flow rate of the hydraulic oil passing through the orifices 7a and 8a is very small, and thus, a pressure loss generated when the hydraulic oil passes through the leaf valve 4 is larger than a pressure loss generated when the hydraulic oil passes through the orifices 7a and 8a. Thus, the damping force is exerted mainly by the leaf valve 4 when the shock absorber D contracts in the extremely low speed range. Note that an inner circumferential surface of the protrusion 2e is a tapered surface inclined such that the distal end side that is the axial upper end is tapered, and thus, when the outer circumferential side of the leaf valve 4 is deflected and separated from the outer circumferential valve seat 2c, the flow path area formed by an annular gap generated between the outer circumferential valve seat 2c and the leaf valve 4 is not limited due to the presence of the protrusion 2e, so that the damping force after the opening of the leaf valve 4 does not become excessive. When there is a risk that the flow path area after the opening of the leaf valve 4 is limited by the protrusion 2e, a plurality of protrusions 2e may be provided at intervals on the outer circumferential side of the outer circumferential valve seat 2c, instead of forming the protrusion 2e into an annular shape, to prevent the protrusion 2e from limiting the flow path area.

In addition, when the contraction speed of the shock absorber D is within a low speed range, the compression side main leaf valve 7 is not opened, but the pressure loss in the orifices 7a and 8a increases, and thus, the shock absorber D exerts the damping force with the leaf valve 4 and the orifices 7a and 8a.

Furthermore, when the extension speed of the shock absorber D becomes high during the extension operation, the compression side main leaf valve 7 is deflected and opened to largely open the compression side main port 6a, and the shock absorber D exerts the damping force mainly with the leaf valve 4 and the compression side main leaf valve 7.

Note that a speed range in which the damping force is generated mainly by the leaf valve 4 is set as an extremely low speed, a speed range in which the damping force is generated mainly by the orifices 7a and 8a is set as a low speed, and a speed range in which the damping force is generated mainly by the compression side main leaf valve 7 or the extension side main leaf valve 8 is set as a high speed in the shock absorber D of the present embodiment as described above. Moreover, the speed for classifying the extremely low speed, the low speed, and the high speed can be set optionally by the designer. In addition, any one of the orifices 7a and 8a can be omitted, and the orifices 7a and 8a may be provided not in the compression side main leaf valve 7 and the extension side main leaf valve 8 but in the piston 6.

Here, the leaf valve 4 is aligned so as to be concentric with the outer circumferential valve seat 2c of the sub-piston 2 radially positioned by the cylinder 1, with the protrusion 2e functioning as the aligning portion of the sub-piston 2. Since the leaf valve 4 is aligned so as to be concentric with the outer circumferential valve seat 2c in this manner, it is possible to prevent a gap from being formed between the outer circumference of the leaf valve 4 to which the initial deflection is given due to the height difference between the outer circumferential valve seat 2c and the inner circumferential valve seat 3c, and the outer circumferential valve seat 2c. On the other hand, the valve stopper 3 having the inner circumferential valve seat 3c is fitted to the piston rod 5 and radially positioned with reference to the piston rod 5. Thus, the leaf valve 4 radially positioned via the sub-piston 2 with reference to the cylinder 1 and the inner circumferential valve seat 3c radially positioned with reference to the piston rod 5 may be eccentric. It has been found through a research by the inventors that even if the annular leaf valve 4 is eccentric with respect to the inner circumferential valve seat 3c, a gap that greatly affects the damping force is not formed between the inner circumference of the leaf valve 4 and the inner circumferential valve seat 3c.

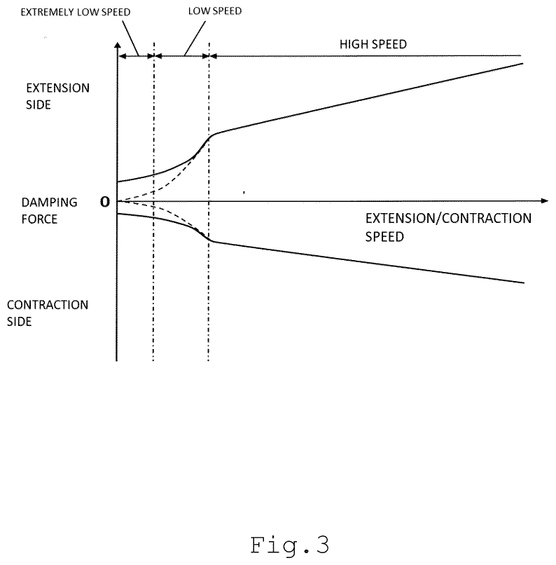

Therefore, in a state where the leaf valve 4 is seated on the outer circumferential valve seat 2c and the inner circumferential valve seat 3c, a gap is not formed between the outer circumference of the leaf valve 4 and the outer circumferential valve seat 2c, and even if the annular leaf valve 4 becomes eccentric with respect to the inner circumferential valve seat 3c, a gap that greatly affects the damping force is not formed between the inner circumference of the leaf valve 4 and the inner circumferential valve seat 3c. From the above, the damping force characteristics when the shock absorber D including the damping valve V1 performs the extension/contraction operation at an extremely low speed are, as illustrated in FIG. 3, characteristics such that a damping force having a sufficient height to suppress the extension/contraction of the shock absorber D is exerted from the start of the movement of the shock absorber D. Note that the damping force characteristics when the shock absorber including a conventional damping valve in which a gap is generated between the leaf valve and the outer circumferential valve seat in a state where the leaf valve is seated on the outer circumferential valve seat, extends and contracts at an extremely low speed are, as indicated by the broken line in FIG. 3, characteristics such that the damping force is insufficient to suppress the extension and contraction of the shock absorber, whereas the shock absorber D of the present embodiment can exert a high damping force capable of suppressing the extension and contraction when the shock absorber D extends and contracts at an extremely low speed.

From the above, the shock absorber D is capable of exerting a sufficient damping force even when the shock absorber D extends and contracts at an extremely low speed, and obtaining good damping force characteristics for suppressing the extension and contraction when the shock absorber D extends and contracts at an extremely low speed.

In addition, when the shock absorber D repeats extension and contraction at an extremely low speed, the compression side main leaf valve 7 and the extension side main leaf valve 8 are not opened, and the leaf valve 4 opens and closes the port 2d. In this manner, when the shock absorber D repeats extension and contraction at an extremely low speed and the shock absorber D is switched from the extension operation to the contraction operation, the sub-piston 2 is separated from the spacer 10 by the action of the pressure of the extension side chamber R1 during the extension operation, and the inner circumference of the leaf valve 4 is deflected and separated from the inner circumferential valve seat 3c. When an extension/contraction direction of the shock absorber D changes from this state to contraction, the leaf valve 4 receives the action of the compression side chamber R2 and returns to a position abutting on the inner circumferential valve seat 3c by its own restoring force, but an impact of a collision of the leaf valve 4 with the inner circumferential valve seat 3c is not transmitted to the piston rod 5 since the sub-piston 2 is separated from the spacer 10. In addition, when the shock absorber D repeats extension and contraction at an extremely low speed and the shock absorber D switches from the contraction operation to the extension operation, the sub-piston 2 is separated from the main valve stopper 12 by the action of the pressure of the intermediate chamber R3 during the contraction operation, and the outer circumference of the leaf valve 4 is deflected and separated from the outer circumferential valve seat 2c. When the extension/contraction direction of the shock absorber D changes from this state to extension, the leaf valve 4 receives the action of the extension side chamber R1 and returns to a position abutting on the outer circumferential valve seat 2c by its own restoring force, but an impact of a collision of the leaf valve 4 with the outer circumferential valve seat 2c is not transmitted to the piston rod 5 since the sub-piston 2 is separated from the main valve stopper 12.

In this manner, in the shock absorber D of the present embodiment, the impact generated when the leaf valve 4 separated from one of the outer circumferential valve seat 2c and the inner circumferential valve seat 3c is seated on one of the outer circumferential valve seat 2c and the inner circumferential valve seat 3c is not transmitted to the piston rod 5, and accordingly, vibration is not applied to the vehicle body.

In addition, in the shock absorber D of the present embodiment, the sub-piston 2 is axially biased in the state where the leaf valve 4 is seated on the outer circumferential valve seat 2c and the inner circumferential valve seat 3e, the sub-piston 2 can be returned to the original position (position where the sub-piston 2 abuts on the main valve stopper 12) even if moving in a direction opposite to a biasing direction of the leaf valve 4, and there is no problem that the port 2d cannot be blocked but is left open regardless of the position of the sub-piston 2. Thus, according to the shock absorber D configured as described above, the damping force as set can be exerted even when the shock absorber extends or contracts at an extremely low speed, and there is no risk that the damping force becomes insufficient to degrade the ride comfort.

As described above, the damping valve V1 of the present embodiment includes: the sub-piston (partition wall body) 2 that is annular, and is inserted into the cylinder (cylindrical body) 1, is radially positioned only by the cylinder (cylindrical body) 1, and has the annular outer circumferential valve seat 2c protruding axially from the axial one end 2b and the port 2d provided on the inner circumferential side of the outer circumferential valve seat 2c; the valve stopper 3 having the annular inner circumferential valve seat 3c facing the one end 2b of the sub-piston (partition wall body) 2 and having an outer diameter smaller than that of the outer circumferential valve seat 2c; and the annular leaf valve 4 that is interposed between the outer circumferential valve seat 2c and the inner circumferential valve seat 3c and is set to be open to both the inside and the outside to open and close the port 2d, wherein the sub-piston (partition wall body) 2 includes the protrusion (aligning portion) 2e that aligns the leaf valve 4 with respect to the outer circumferential valve seat 2c.

In the damping valve V1 configured as described above, since the leaf valve 4 is aligned with respect to the outer circumferential valve seat 2c by the protrusion (aligning portion) 2e provided in the sub-piston (partition wall body) 2 radially positioned only by the cylinder (cylindrical body) 1, in a state where the leaf valve 4 is seated on the outer circumferential valve seat 2c and the inner circumferential valve seat 3c, a gap is not formed between the outer circumference of the leaf valve 4 and the outer circumferential valve seat 2c, and a gap that affects the damping force is also not formed between the inner circumference of the leaf valve 4 and the inner circumferential valve seat 3c. According to the damping valve V1 of the present embodiment, it is possible to prevent the leakage of the hydraulic oil from the gap, and generate a sufficient damping force in the shock absorber D even when the flow rate of the hydraulic oil passing through the port 2d is small. Therefore, according to the damping valve V1 of the present embodiment, it is possible to obtain good damping force characteristics for suppressing the extension and contraction even when the shock absorber D extends and contracts at an extremely low speed.

In addition, in the damping valve V1 of the present embodiment, the aligning portion provided in the sub-piston (partition wall body) 2 is the protrusion 2e that protrudes axially from the outer circumferential side of the one end 2b of the sub-piston (partition wall body) 2 with respect to the outer circumferential valve seat 2c and abuts on the outer circumference of the leaf valve 4. In this manner, when the protrusion 2e provided in close proximity to the outer circumferential valve seat 2c is used as the aligning portion, the alignment accuracy of the leaf valve 4 with respect to the outer circumferential valve seat 2c improves.

Furthermore, the damping valve V1 of the present embodiment is configured to include: the piston (main partition wall body) 6 that is inserted into the cylinder (cylindrical body) 1 so as to face the sub-piston (partition wall body) 2 axially and includes the compression side main port (main port) 6a and the extension side main port (main port) 6b; and the main valve that is formed of the compression side main leaf valve 7 that opens and closes the compression side main port (main port) 6a and is set to a higher valve opening pressure than the valve opening pressure of the leaf valve 4, and the extension side main leaf valve 8 that opens and closes the extension side main port (main port) 6b and is set to a higher valve opening pressure than the valve opening pressure of the leaf valve 4. According to the damping valve V1 configured as described above, it is possible to exert a suitable damping force with the leaf valve 4 when the shock absorber D extends and contracts at an extremely low speed, and to exert a large damping force with the main valve when the extension and contraction speed of the shock absorber D becomes high. Therefore, according to the damping valve V1 of the present embodiment, it is possible to generate a damping force suitable for suppressing the extension and contraction of the shock absorber D in the shock absorber D according to the extension and contraction speed of the shock absorber D. In addition, in the damping valve V1 of the present embodiment in which the piston (main partition wall body) 6 is fixed to the piston rod 5 and inserted into the cylinder (cylindrical body) 1, the sub-piston 2 can move radially with respect to the piston rod 5, and thus sliding resistance between the sub-piston 2 and the cylinder 1 does not increase even if there is a dimensional error in the piston 6, the piston rod 5, or the sub-piston 2. Thus, according to the shock absorber D configured as described above, even if the structure in which the piston (main partition wall body) 6 and the sub-piston 2 are slidably in contact with the cylinder 1 is adopted, the sliding resistance does not increase and smooth extension and contraction is possible, so that high-level dimensional control is not required and thus the cost is also lowered. Note that when the main port allows bidirectional flow instead of one-way flow, the main valve may be configured as one valve, and in this case, the main valve may be a de Carbon valve, for example.

In addition, the shock absorber D of the present embodiment includes the cylinder 1, the piston rod 5 inserted into the cylinder 1, and the damping valve V1, wherein the cylinder 1 is a cylindrical body. According to the shock absorber D configured as described above, since the damping valve V1 is provided, it is possible to exert a sufficient damping force and to obtain good damping force characteristics for suppressing the extension and contraction even when the shock absorber D extends and contracts at an extremely low speed.

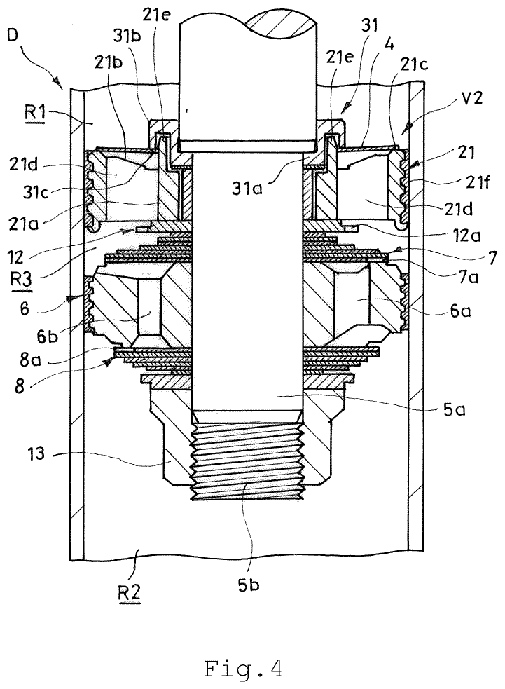

In the damping valve V1 of the above-described embodiment, the protrusion 2e abutting on the outer circumference of the leaf valve 4 is provided on the outer circumferential side of the outer circumferential valve seat 2c of the sub-piston 2, and the protrusion 2e is used as the aligning portion. However, as in a damping valve V2 of one modification of the one embodiment illustrated in FIG. 4, a protrusion 21e protruding axially from the inner circumferential side of a sub-piston 21 with respect to a port 21d and abutting on the inner circumference of the leaf valve 4 may be provided, and the protrusion 21e may be used as the aligning portion. In the description of the damping valve V2 of the one modification, the same reference numerals are given to the same components as those of the damping valve V1 of the one embodiment and the detailed description thereof is omitted in order to avoid duplication of description.

The sub-piston 21 as a partition wall body in the damping valve V2 in the one modification is identical to the sub-piston 2 in the damping valve V1 of the one embodiment in that the sub-piston 21 includes an annular main body 21a, an annular outer circumferential valve seat 21c protruding axially from one end 21b of the main body 21a that is the axial upper end in FIG. 3, a plurality of ports 21d provided side by side on the same circumference on the inner circumferential side of the outer circumferential valve seat 21c in the main body 21a, and a piston ring 21f that is mounted on an outer circumference of the main body 21a and slidably in contact with the inner circumference of the cylinder 1. On the other hand, the sub-piston 21 has a different configuration from that of the sub-piston 2 in that the sub-piston 21 includes a plurality of protrusions 21e at equal intervals on the same circumference on the inner circumference of the one end 21b of the main body 21a with respect to the port 21d, instead of including the protrusion on the outer circumferential side of the outer circumferential valve seat 21c.

If the protrusion 21e is ignored, an axial height of the one end 21b of the main body 21a increases from the inner circumference toward the outer circumference, and an axial length of the main body 21a on the inner circumferential side is slightly shorter than an axial length of the collar 11.

As described above, the ports 21d are arranged at equal intervals on the same circumference concentric with respect to the main body 21a, and cause the intermediate chamber R3 between the sub-piston 2 and the piston 6 to communicate with the extension side chamber R1 through the main body 21a.

The outer circumferential valve seat 21c protrudes axially to the upper side in FIG. 2 from the main body 21a so as to surround an outer circumference of the port 21d. In addition, when the sub-piston 21 is viewed from the upper side in FIG. 4, the protrusion 21e has an arc-shaped cross section with a curved outer circumferential surface, and the outer circumferential surfaces of the protrusions 21e have the same curvature and are in contact with the same circle.

Furthermore, the protrusions 21e are provided circumferentially at intervals so as not to radially overlap the port 21d, considering that the flow path area of the port 21d is not reduced when the protrusions 21e are provided. That is, a part of the port 21d is also formed between the protrusions 21e and 21e in the circumferential direction of the sub-piston 21, but in particular, when there is no problem in securing the flow path area of the port 21d, the part of the port 21d may not be provided between the protrusions 21e and 21e.

When the sub-piston 21 is loosely fitted to the collar 11, a gap is formed between an inner circumference of the sub-piston 21 and the collar 11, and thus the sub-piston 21 can be slightly displaced in the vertical direction in FIG. 4, which is the axial direction. In addition, when the sub-piston 21 is inserted into the cylinder 1, an outer circumference of the piston ring 21f comes slidably in contact with the inner circumference of the cylinder 1, and the sub-piston 21 is loosely fitted to the collar 11, and thus the sub-piston 21 is radially positioned only by the cylinder 1.

As illustrated in FIG. 4, the valve stopper 31 in the one modification includes a fitting portion 31a that is annular and has a reduced inner diameter on the lower end side in FIG. 4, a flange portion 31b protruding to an outer circumferential side from an end of the fitting portion 31a protruding to the upper side in FIG. 4 with respect to the protrusion 21e of the sub-piston 21 and facing the upper end in FIG. 4 of the protrusion 21e with a gap, and an annular inner circumferential valve seat 31c extending from an outer circumference of the flange portion 31b to the sub-piston 21 side and arranged on an outer circumference of the protrusion 21e to face the sub-piston 21. An inner diameter of the fitting portion 31a on the lower end side in FIG. 2 is set to be able to be fitted to the outer circumference of the small-diameter portion 5a of the piston rod 5, and the inner diameter of the fitting portion 31a on the upper end side in FIG. 4 is larger than an outer diameter of the piston rod 5 on the upper side of the small-diameter portion 5a in FIG. 2. Thus, when the valve stopper 31 is fitted to the small-diameter portion 5a of the piston rod 5, the inner circumference of the fitting portion 31a on the lower end side is fitted to the small-diameter portion 5a of the piston rod 5, and thus the valve stopper 31 is radially positioned with respect to the piston rod 5, while the stepped portion at a boundary between the lower end and the upper end of the fitting portion 31a abuts on the stepped portion 5c of the piston rod 5, and thus the valve stopper 3 is axially positioned with respect to the piston rod 5.

In addition, when the sub-piston 21 is loosely fitted to the outer circumference of the collar 11 after the valve stopper 31 is installed to the piston rod 5 together with the spacer 10 and the collar 11, the protrusion 21e of the sub-piston 21 is accommodated in the annular gap formed between the fitting portion 31a and the inner circumferential valve seat 31c, and the inner circumferential valve seat 31c faces the inner circumferential side of the main body 21a of the sub-piston 21. The outer diameter of the inner circumferential valve seat 31c of the valve stopper 31 is smaller than an inner diameter of the outer circumferential valve seat 21c, and the outer circumferential valve seat 21c is arranged at a higher position in FIG. 4 than the inner circumferential valve seat 31c.

The inner diameter of the leaf valve 4 is set to be smaller than the outer diameter of the inner circumferential valve seat 31c and to be in contact with an outer circumferential surface of each protrusion 21e of the sub-piston 21, and the outer diameter is set to be larger than the inner diameter of the outer circumferential valve seat 2c. Thus, when the leaf valve 4 is placed on the sub-piston 21, since the inner circumference of the leaf valve 4 abuts on each protrusion 21e of the sub-piston 21, the leaf valve 4 is aligned with respect to the outer circumferential valve seat 21c of the sub-piston 2 by the protrusion 21e and is radially positioned so as to be concentric with the outer circumferential valve seat 21c. In this manner, the protrusion 21e functions as an aligning portion that aligns the leaf valve 4 with respect to the outer circumferential valve seat 21c.

The protrusion 21e may not have an arc shape as long as it can align the leaf valve 4 so as to be concentric with respect to the outer circumferential valve seat 21c, but when the arc shape is used, the inner circumference of the leaf valve 4 easily slides on the outer circumferential surface of the protrusion 21e, which can ensure smooth deflection of the inner circumference of the leaf valve 4.

The leaf valve 4 is interposed between the inner circumferential valve seat 31c and the outer circumferential valve seat 21c in a state where the upper end in FIG. 4 of the inner circumference is seated on the inner circumferential valve seat 31c and the lower end in FIG. 4 of the outer circumference is seated on the outer circumferential valve seat 2c. Thus, similarly to the damping valve V1, the leaf valve 4 in the damping valve V2 in the one modification functions as a de Carbon valve that is open to both the inside and the outside. Since the axial height of the main body 21a in the sub-piston 21 decreases as it goes toward the inner circumference, a sufficient space such that the inner circumference of the leaf valve 4 can be deflected to the lower side in FIG. 4 is secured between the inner circumferential valve seat 31c and the main body 21a of the sub-piston 21. In addition, since the protrusions 21e are circumferentially provided at intervals, when the inner circumference of the leaf valve 4 is separated from the inner circumferential valve seat 31c, the extension side chamber R1 and the port 21d communicate with each other through the gap between the protrusions 21e and 21e.

In addition, since the outer circumferential valve seat 21c of the sub-piston 21 is arranged at a higher position in FIG. 4 than the inner circumferential valve seat 31c of the valve stopper 31, the leaf valve 4 is given an initial deflection when interposed between the inner circumferential valve seat 31c and the outer circumferential valve seat 21c, according to the difference in height between the inner circumferential valve seat 31c and the outer circumferential valve seat 21c. Since the leaf valve 4 is given the initial deflection in this manner, a valve opening pressure at which the leaf valve 4 is separated from the inner circumferential valve seat 31c and the outer circumferential valve seat 21c is set, and thus the valve opening pressure can be adjusted by adjusting the initial deflection amount. Note that, since the initial deflection amount given to the leaf valve 4 can be adjusted based on the difference in the axial distance between the inner circumferential valve seat 31c and the outer circumferential valve seat 21c, the valve opening pressure can be adjusted by adjusting the thickness of the annular plate of the spacer 10 and the number of stacked plates.

In the damping valve V2 in the one modification, similarly to the damping valve V1, the main valve stopper 12, the compression side main leaf valve 7, the piston 6, and the extension side main leaf valve 8 are provided on the lower side in FIG. 4 of the sub-piston 21. Thus, the damping valve V2 generates a damping force in the shock absorber D with the leaf valve 4 when the shock absorber D extends and contracts at an extremely low speed, with the orifices 7a and 8a when the shock absorber D extends and contracts at a low speed, and with the compression side main leaf valve 7 or the extension side main leaf valve 8 when the shock absorber D extends and contracts at a high speed.

In addition, also in the damping valve V2 in the one modification, the leaf valve 4 is aligned so as to be concentric with the outer circumferential valve seat 21c of the sub-piston 21 radially positioned by the cylinder 1, with the protrusion 21e functioning as the aligning portion of the sub-piston 21. In this manner, since the leaf valve 4 is aligned so as to be concentric with the outer circumferential valve seat 21c, in a state where the leaf valve 4 is seated on the outer circumferential valve seat 2c and the inner circumferential valve seat 3c, a gap is not formed between the outer circumference of the leaf valve 4 and the outer circumferential valve seat 2c, and even if the annular leaf valve 4 becomes eccentric with respect to the inner circumferential valve seat 3c, a gap that greatly affects the damping force is not formed between the inner circumference of the leaf valve 4 and the inner circumferential valve seat 3c. From the above, the damping force characteristics when the shock absorber D including the damping valve V2 performs the extension/contraction operation at an extremely low speed are, as illustrated in FIG. 3, characteristics such that a damping force having a sufficient height to suppress the extension/contraction of the shock absorber D is exerted from the start of the movement of the shock absorber D. From the above, the shock absorber D is capable of exerting a sufficient damping force even when the shock absorber D extends and contracts at an extremely low speed, and obtaining good damping force characteristics for suppressing the extension and contraction when the shock absorber D extends and contracts at an extremely low speed.

As described above, the damping valve V2 in the one modification of the present embodiment includes: the sub-piston (partition wall body) 21 that is annular, and is inserted into the cylinder (cylindrical body) 1, is radially positioned only by the cylinder (cylindrical body) 1, and has the annular outer circumferential valve seat 21c protruding axially from the axial one end 21b and the port 21d provided on the inner circumferential side of the outer circumferential valve seat 21c; the valve stopper 31 having the annular inner circumferential valve seat 31c facing the one end 21b of the sub-piston (partition wall body) 21 and having an outer diameter smaller than that of the outer circumferential valve seat 21c; and the annular leaf valve 4 that is interposed between the outer circumferential valve seat 21c and the inner circumferential valve seat 31c and is set to be open to both the inside and the outside to open and close the port 21d, wherein the sub-piston (partition wall body) 21 includes the protrusion (aligning portion) 21e that aligns the leaf valve 4 with respect to the outer circumferential valve seat 21c.

In the damping valve V2 configured as described above, since the leaf valve 4 is aligned with respect to the outer circumferential valve seat 21c by the protrusion (aligning portion) 21e provided in the sub-piston 21 positioned only by the cylinder (cylindrical body) 1, in a state where the leaf valve 4 is seated on the outer circumferential valve seat 21c and the inner circumferential valve seat 31c, a gap is not formed between the outer circumference of the leaf valve 4 and the outer circumferential valve seat 2c, and a gap that affects the damping force is also not formed between the inner circumference of the leaf valve 4 and the inner circumferential valve seat 31c. According to the damping valve V2 of the present embodiment, it is possible to prevent the leakage of the hydraulic oil from the gap, and generate a sufficient damping force in the shock absorber D even when the flow rate of the hydraulic oil passing through the port 21d is small. Therefore, according to the damping valve V2 of the present embodiment, it is possible to obtain good damping force characteristics for suppressing the extension and contraction even when the shock absorber D extends and contracts at an extremely low speed.

In addition, in the damping valve V2 of the present embodiment, the aligning portion provided in the sub-piston (partition wall body) 2 is a plurality of protrusions 21e that protrude axially at circumferential intervals from the inner circumferential side of the one end 21b of the sub-piston (partition wall body) 2 with respect to the port 21d and abuts on the inner circumference of the leaf valve 4. In this manner, when the protrusion 21e provided on the inner circumferential side with respect to the port 21d is used as the aligning portion, the outer diameter of the leaf valve 4 can be made smaller than the outer diameter of the outer circumferential valve seat 21c, and thus the degree of freedom in designing the leaf valve 4 improves.

In the present embodiment, the damping valves V1 and V2 are mounted on the piston rod 5, and the damping valves V1 and V2 are installed in the piston portion of the shock absorber D. However, in a case where the shock absorber D is a shock absorber having a reservoir chamber that stores liquid on the outer circumferential side of the cylinder 1, a partition wall body or a partition wall body and a main partition wall body that define the compression side chamber R2 and the reservoir may be provided at the end of the cylinder 1, and the damping valves V1 and V2 may be installed between the compression side chamber R2 and the reservoir chamber. That is, the damping valves V1 and V2 may be installed in the base valve portion of the shock absorber D. Furthermore, since the damping valves V1 and V2 may be installed at positions where a damping force can be generated when the shock absorber D extends and contracts, the installation positions of the damping valves V1 and V2 vary depending on the configuration of the shock absorber D, but the damping valves V1 and V2 may be installed at optimal positions depending on the configuration of the shock absorber D.

In addition, since the damping valves V1 and V2 can generate the damping force only with the leaf valve 4 without including the main partition wall body having the main port and the main valve that opens and closes the main port, it is a matter of course that the damping valves V1 and V2 including the partition wall body 2 (21), the valve stopper 3 (31), and the leaf valve 4 without including the main partition wall body and the main valve can be used in the shock absorber D.

The detailed description of preferred embodiments of the present invention has been made above, however, modifications, variations, and changes thereof can be made without departing from the scope of the claims.

### REFERENCE SIGNS LIST

1 Cylinder (Cylindrical body)
2, 21 Sub-piston (partition wall body)
2b, 21b One end of sub-piston
2c, 21c Outer circumferential valve seat
2d, 21d Port
2e, 21e Protrusion (aligning portion)
3, 31 Valve stopper
3c, 31c Inner circumferential valve seat
4 Leaf valve
5 Piston rod
6 Piston (main partition wall body)
6a Compression side main port (main port)
6b Extension side main port (main port)
7 Compression side main leaf valve (main valve)
8 Extension side main leaf valve (main valve)
D Shock absorber
V1, V2 Damping valve

1. A damping valve comprising:
a partition wall body that is annular, is inserted into a cylindrical body, is radially positioned only by the cylindrical body, and has an annular outer circumferential valve seat protruding axially from axial one end and a port provided on an inner circumferential side of the outer circumferential valve seat;
a rod that is inserted into an inner circumference of the partition wall body;
a valve stopper that has an annular inner circumferential valve seat facing the one end of the partition wall body and having an outer diameter smaller than that of the outer circumferential valve seat; and
an annular leaf valve that is interposed between the outer circumferential valve seat and the inner circumferential valve seat and is set to be open to both the inside and the outside to open and close the port, wherein
the partition wall body includes an aligning portion that aligns the leaf valve with respect to the outer circumferential valve seat, and is radially movable with respect to the rod.

2. The damping valve according to claim 1, wherein
the aligning portion is a protrusion that protrudes axially from an outer circumferential side of the one end of the partition wall body with respect to the outer circumferential valve seat and abuts on an outer circumference of the leaf valve.

3. The damping valve according to claim 1, wherein
the aligning portion is a protrusion that protrudes axially from an inner circumferential side of the partition wall body with respect to the port and abuts on an inner circumference of the leaf valve.

4. The damping valve according to claim 1, comprising:
a main partition wall body that faces the partition wall body axially, is inserted into the cylindrical body, and has a main port; and
a main valve that opens and closes the main port and is set to a valve opening pressure higher than a valve opening pressure of the leaf valve.

5. A shock absorber comprising:
a cylinder;
a piston rod inserted into the cylinder;
the damping valve according to claim 1, wherein
the cylinder is the cylindrical body.

6. A shock absorber comprising:
a cylinder;
a piston rod inserted into the cylinder;
the damping valve according to claim 2, wherein
the cylinder is the cylindrical body.

7. A shock absorber comprising:
a cylinder;
a piston rod inserted into the cylinder;
the damping valve according to claim 3, wherein
the cylinder is the cylindrical body.

8. A shock absorber comprising:
a cylinder;
a piston rod inserted into the cylinder;
the damping valve according to claim 4, wherein
the cylinder is the cylindrical body.

9. A shock absorber comprising:
a cylinder;
a piston rod inserted into the cylinder;
the damping valve according to claim 5, wherein
the cylinder is the cylindrical body.

10. The damping valve according to claim 2, wherein
the leaf valve is radially aligned only by a protrusion that abuts on an outer circumference of the leaf valve.

11. A shock absorber comprising:
a cylinder;
a piston rod inserted into the cylinder;
the damping valve according to claim 10, wherein
the cylinder is the cylindrical body.
